(19) United States
(12) Patent Application Publication
(10) Pub. No.: US 2024/0198707 A1
(43) Pub. Date: Jun. 20, 2024

(54) PRINTING METHOD AND PRINTING DEVICE

(71) Applicant: MIMAKI ENGINEERING CO., LTD., Nagano (JP)

(72) Inventor: Akira Takatsu, Nagano (JP)

(73) Assignee: MIMAKI ENGINEERING CO., LTD., Nagano (JP)

(21) Appl. No.: 18/287,017

(22) PCT Filed: Mar. 2, 2022
(86) PCT No.: PCT/JP2022/008922

§ 371 Date: Oct. 15, 2023

(30) Foreign Application Priority Data
Apr. 16, 2021 (JP) 2021-069761
Apr. 30, 2021 (JP) 2021-078068

(51) Int. Cl. B41M 3/00

(52) U.S. Cl. CPC B41M 3/008

(57) ABSTRACT

A printing method and a printing device are provided to reduce a difference in a degree of wet-spreading of a coating material. The printing method includes: a buffer layer forming step of forming, when there is a difference between a surface free energy of a print object which is an object to be printed and a surface free energy of a coating material applied to a surface of the print object, a buffer layer on the surface of the print object with a buffer material having a surface free energy differing from that of the print object or the coating material; and a printing step of printing by applying the coating material to the buffer layer.

### TECHNICAL FIELD

The present invention relates to a printing method, a printing device, and a printed matter.

### BACKGROUND ART

Patent Literatures 1 and 2 disclose a printing device that prints by applying ink to a print object to be printed.

### CITATION LIST

### Patent Literature

Patent Literature 1: Japanese Unexamined Patent Publication No. 2019-14065
Patent Literature 2: Japanese Unexamined Patent Publication No. 2018-187891

### SUMMARY OF INVENTION

### Technical Problems

When printing using the printing device described in Patent Literatures 1 and 2, depending on a type of the print object and viscosity of the ink as a coating material, wet-spreading of the coating material on the print object may be insufficient or excessive.

The present invention has been achieved in light of the above. The present invention provides a printing method, a printing device, and a printed matter capable of reducing a difference in a degree of wet-spreading of a coating material on a print object depending on a type of the print object and viscosity of the coating material.

### Solutions to Problems

A printing method of the present invention includes: a buffer layer forming step of forming, when there is a difference between a surface free energy of a print object which is an object to be printed and a surface free energy of a coating material to be applied to a surface of the print object, a buffer layer on the surface of the print object with a buffer material having a surface free energy differing from that of the print object or the coating material; and a printing step of printing by applying the coating material to the buffer layer.

A printing device of the present invention includes: a droplet ejecting portion, configured to be capable of ejecting droplets of a coating material toward a surface of a print object; a buffer layer forming portion, configured to be capable of forming a buffer layer that adjusts an arrangement state of the coating material on the surface of the print object; and a controller, configured to cause the buffer layer forming portion to form the buffer layer and the droplet ejecting portion to apply the coating material onto the buffer layer, when an absolute value of a difference between a surface free energy of the print object and a surface free energy of the coating material is equal to or greater than a threshold.

According to the present invention, the buffer layer is formed on the surface of the print object using the buffer material having surface free energy differing from that of the print object or the coating material, and the coating material is applied onto the buffer layer, thereby performing printing. Therefore, both excessive wet-spreading and insufficient wet-spreading of the coating material can be reduced. Consequently, the difference in the degree of wet-spreading of the coating material depending on a type of the print object can be reduced. Note that, in the present invention, a case in which there is a difference between the surface free energy of the print object and the surface free energy of the coating material can be, for example, a case in which there is a difference of 1 mJ/m² or greater between the surface free energies.

The printing method of the present invention further includes a determining step of determining whether or not to form the buffer layer based on the difference between the surface free energy of the print object and the surface free energy of the coating material, in which, when it is determined to form the buffer layer, forming the buffer layer on the surface of the print object. In addition, the determining step determines that the buffer layer is to be formed, when an absolute value of the difference between the surface free energy of the print object and the surface free energy of the coating material is equal to or greater than a threshold. Consequently, the difference in the degree of wet-spreading of the coating material can be further reduced.

In the printing method of the present invention, the buffer layer is formed by using, as the buffer material, at least one of a clear ink, a primer, and an ink of same color as the print object having a surface free energy corresponding to the absolute value of the difference between the surface free energy of the print object and the surface free energy of the coating material. Consequently, an arrangement state of ink on the buffer layer can be appropriately secured.

In the printing method of the present invention, the print object includes: a print object having a surface free energy greater than the surface free energy of the coating material, and a print object having a surface free energy less than the surface free energy of the coating material. Consequently, the difference in the degree of wet-spreading of the coating material can be reduced when the coating material is applied to a plurality of types of print objects having a range of surface free energies.

The printing method of the present invention forms the buffer layer over an entire region in which the coating material is applied on the surface of the print object or an entire surface of the print object. Consequently, the difference in the degree of wet-spreading can be reduced over the entire coating material.

In the printing device of the present invention, the controller further includes: a storage, configured to store therein an information of surface free energies of a plurality of print objects and surface free energies of a plurality of coating materials; an absolute value calculating portion, configured to calculate the absolute value of the difference between the surface free energy of the print object to be printed and the surface free energy of the coating material, from the information of surface free energies of the plurality of print objects and surface free energies of the plurality of coating materials; a threshold determining portion, configured to determine whether or not the absolute value is equal to or greater than the threshold; and a buffer layer formation determining portion, configured to determine whether or not to form the buffer layer based on the threshold. Consequently, whether or not to form the buffer layer can be efficiently determined.

The printing method of the present invention includes: ejecting droplets of a first ink from a nozzle of a first head onto a print object while moving the first head in a main scanning direction set in advance; and ejecting droplets of a second ink having a higher viscosity than that of the first ink from a nozzle of a second head onto the print object, the second head being arranged side by side with the first head in the main scanning direction and moving integrally with the first head, in which the droplets of the first ink and the droplets of the second ink are ejected in an overlapping manner so as to correspond one-to-one on target landing positions for the droplets of the first ink on the print object.

The printing device of the present invention includes: a first head, configured to be movable in a main scanning direction set in advance and ejects droplets of a first ink from a nozzle onto a print object; a second head, configured to be arranged side by side in the main scanning direction with the first head, moves integrally with the first head, and ejects droplets of a second ink having a higher viscosity than that of the first ink from a nozzle onto the print object; and a controller, configured to control an ejection operation of the first head and the second head, so that the droplets of the first ink ejected from the nozzle of the first head and the droplets of the second ink ejected from the nozzle of the second head overlap so as to correspond one-to-one on the target landing position of the droplets of the first ink on the print object.

According to the present invention, the droplets of the first ink and the droplets of the second ink are ejected in an overlapping manner so as to correspond one-to-one on the target landing positions of the droplets of the first ink on the print object. The droplets of the first ink can thereby be brought into contact with the second ink. Consequently, the wet-spreading of the first ink can be reduced.

In the printing method of the present invention, the second ink is at least one ink among an ink of the same type of color as the first ink, an ink of the same type of color as the print object, and a transparent ink. Consequently, the first ink can be selected from a wide variety of inks.

The printing method of the present invention ejects the droplets of the second ink onto the target landing positions and subsequently ejects the droplets of the first ink so as to overlap the droplets of the second ink, when ejection of the droplets of the second ink is performed before ejection of the droplets of the first ink onto the target landing positions. In addition, the droplets of the first ink are ejected onto the target landing positions and the droplets of the second ink are subsequently ejected so as to overlap the droplets of the first ink, when ejection of the droplets of the second ink is performed before ejection of the droplets of the first ink onto the target landing positions. Consequently, even when either of the first ink and the second ink is ejected earlier, the droplets of the first ink can be brought into contact with the second ink.

The printing method of the present invention ejects, in a single main scan of the first head and the second head, the droplets of the first ink and the droplets of the second ink are ejected in an overlapping manner on the target landing positions. Consequently, the droplets of the first ink can be brought into contact with the second ink in a single main scan.

The printing method in the present invention is a printing method using the first head and the second head respectively having nozzle rows constituted by the same number of nozzles that are arranged in a sub scanning direction orthogonal to the main scanning direction; in which, for each main scan, an ejection control is performed by the nozzle rows being divided into segments that divide the nozzle rows into N equal parts (N being a natural number) in the sub scanning direction; and for each main scan, the nozzles from which ink is ejected from the first head and the second head are nozzles of segments adjacent to each other in the main scanning direction. Consequently, a layer of the first ink and a layer of the second ink can be formed for each region in the sub scanning direction.

In the printing method of the present invention, a base layer is formed by the droplets of the second ink being ejected in a predetermined region on the print object including the target landing positions in a single main scan of the first head and the second head, and the first ink is subsequently ejected so as to overlap the second ink ejected onto the target landing positions on the base layer in a subsequent main scan continuing from the single main scan of the first head and the second head. Consequently, even when the first ink is ejected onto the base layer, the droplets of the first ink can be brought into contact with the second ink. In this case, the printing method uses the first head and the second head respectively having nozzle rows constituted by the same number of nozzles that are arranged in a sub scanning direction orthogonal to the main scanning direction; for each main scan, ejection control is performed by the nozzle rows being divided into segments that divide the nozzle rows into N equal parts (N being a natural number) in the sub scanning direction; in the single main scan, the droplets of the second ink are ejected from the nozzles of a single segment among the segments of N equal parts among the nozzle rows of the second head; the print object is conveyed in the sub scanning direction by a nozzle row length dividing the nozzle rows into N equal parts; and in the subsequent main scan, the first head ejects the droplets of the first ink from the nozzles in the segment continuous with the segment from which the droplets of the second ink are ejected from the second head in the sub scanning direction. Consequently, a layer of the first ink and a layer of the second ink can be formed for each region in the sub scanning direction.

The printing method of the present invention ejects at least the droplets of the first ink onto the target landing positions, and subsequently forms a coating layer by ejecting the second ink onto a predetermined region on the print object including the target landing positions. Consequently, the layer of the first ink can be protected by the coating layer in a state in which the wet-spreading of the first ink is reduced.

Further, a printed matter of the present invention includes: a print object; droplets of a first ink, being arranged in target landing positions on the print object; and droplets of a second ink, having a higher viscosity than that of the first ink, and being arranged so as to overlap the droplets of the first ink on the target landing positions on which the first ink is arranged, so as to correspond one-to-one. Consequently, a printed matter in which the wet-spreading of the first ink is reduced can be provided.

### Effect of the Invention

According to the present invention, a printing method, a printing device, and a printed matter capable of reducing a difference in a degree of wet-spreading of a coating material on a print object can be provided.

### BRIEF DESCRIPTION OF THE DRAWINGS

FIG. 1 shows diagrams of an example of a printing device according to a first embodiment.

FIG. 2 shows diagrams of an example of physical property information stored in physical property information storage.

FIG. 3 shows diagrams of an example of a state of a first ink ejected onto a print object or a buffer layer.

FIG. 4 shows diagrams of an example of a state of the first ink ejected onto the buffer layer.

FIG. 5 is a flowchart of an example of a printing method in a printing method according to the first embodiment.

FIG. 6 is a diagram of an example of a printing device according to a second embodiment.

FIG. 7 is a diagram of an example of an ejection surface side of a first head and a second head.

FIG. 8 is a diagram of an example of an ejection operation in a printing method according to the second embodiment.

FIG. 9 is a diagram of an example of a state of a first ink and a second ink ejected onto a print object in main scans on forward and return paths.

FIG. 10 is a diagram of an example of a state of the first ink and the second ink on the print object when a printing operation is completed.

FIG. 11 is a diagram of another example of the ejection operation in the printing method according to the second embodiment.

FIG. 12 shows diagrams of an example of the state of the first ink and the second ink on the print object when the printing operation is completed.

FIG. 13 is a diagram of another example of the ejection operation in the printing method according to the second embodiment.

FIG. 14 is a diagram of another example of the state of the first ink and the second ink on the print object when the printing operation is completed.

FIG. 15 is a diagram of another example of the ejection operation in the printing method according to the second embodiment.

FIG. 16 is a diagram of another example of the ejection operation in the printing method according to the second embodiment.

### DESCRIPTION OF EMBODIMENTS

Hereinafter, preferred embodiments for carrying out the present invention will be described. Note that the present invention is not limited to these embodiments.

### First Embodiment

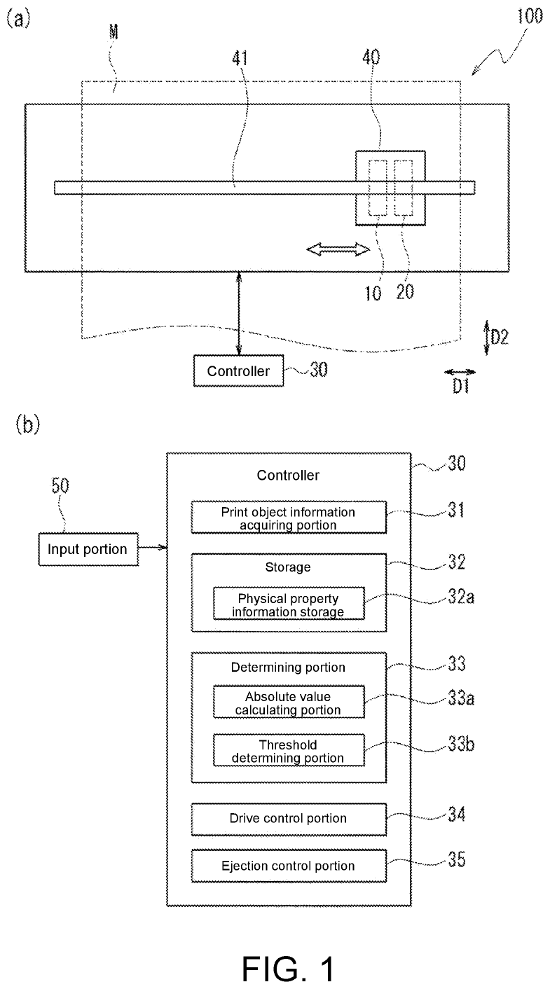

In FIG. 1, (a) and (b) are diagrams of an example of a printing device according to a first embodiment.

As shown in (a) and (b) of FIG. 1, a printing device 100 includes a first droplet ejecting portion 10, a second droplet ejecting portion 20, and a controller 30. The first droplet ejecting portion 10 and the second droplet ejecting portion 20 are mounted on a carriage 40. The carriage 40 is movable in a main scanning direction D1 along a guide bar 41.

The printing device 100 further includes a relative moving portion (not shown) that relatively moves the first droplet ejecting portion 10 and the second droplet ejecting portion 20, and a print object M in a sub scanning direction D2. According to the first embodiment, a case in which a print object conveyance section that moves the print object M in the sub scanning direction D2 is used as the relative moving portion will be described as an example. Note that the relative moving portion may be configured to be capable of moving the first droplet ejecting portion 10 and the second droplet ejecting portion 20 in the sub scanning direction D2.

The first droplet ejecting portion 10 or the second droplet ejecting portion 20 may be a mechanism for spraying fine droplets of ink, such as an inkjet head or a spray, or may be a mechanism for continuously ejecting liquid, such as a dispenser. The present invention is also not limited thereto. The controller 30 controls the ejection of ink from the first droplet ejecting portion 10 and the second droplet ejecting portion 20, the movement of the carriage 40 in the main scanning direction D1, and the movement of the print object M in the sub scanning direction D2.

As the print object M, for example, a non-permeable print object using metal, resin, or the like that is non-permeable to ink, or a permeable print object using fabric, paper, or the like that is permeable to ink is applicable. Any material is applicable as the print object M as long as an image can be formed on the print object M. In addition, the print object M has a formation surface (front surface) on which an image is formed. The surface may be an uneven surface, a flat surface, or a curved surface in shape. The surface may have any shape on which an image can be formed.

As shown in (a) of FIG. 1, the first droplet ejecting portion 10 and the second droplet ejecting portion 20 are arranged side by side in the main scanning direction D1 in the carriage 40. When the carriage 40 moves in the main scanning direction D1, the first droplet ejecting portion 10 and the second droplet ejecting portion 20 also move integrally in the main scanning direction D1. Note that the first droplet ejecting portion 10 and the second droplet ejecting portion 20 may be mounted on separate carriages 40 and perform scanning separately.

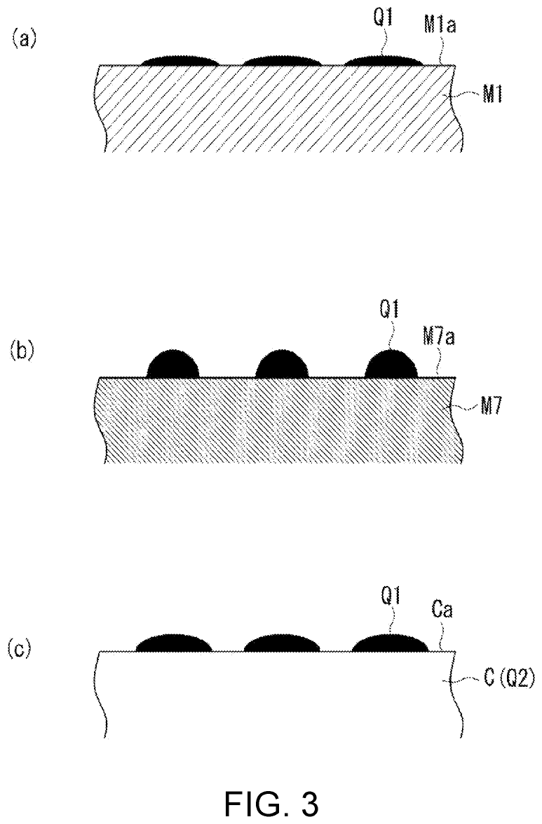

The first droplet ejecting portion 10 ejects droplets of a first ink Q1 (see FIG. 3) from a nozzle toward the print object M while moving in the main scanning direction D1. The first ink Q1 is made of a coating material. The first droplet ejecting portion 10 forms an ink layer on the print object M.

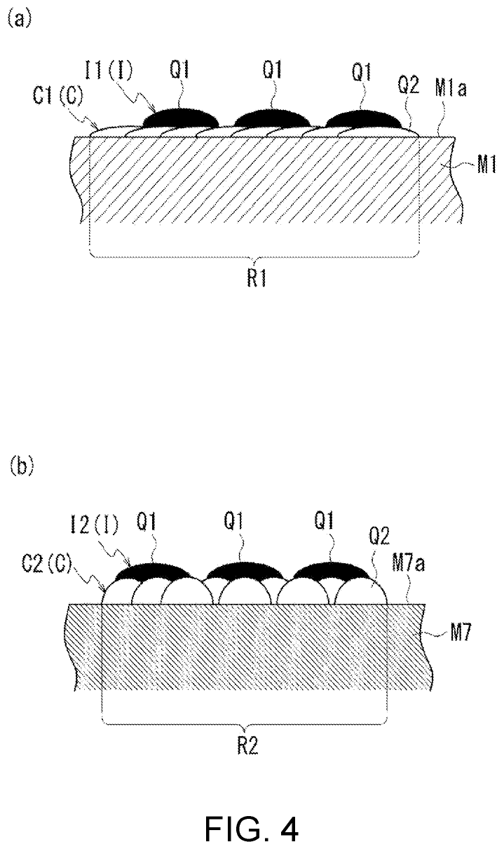

The second droplet ejecting portion 20 ejects droplets of a second ink Q2 (see FIG. 4) from a nozzle toward the print object M while moving in the main scanning direction D1. The second ink Q2 is made of a buffer material. Although details will be described hereafter, the second droplet ejecting portion 20 forms a buffer layer interposed between the print object M and the ink layer.

As the first ink Q1 and the second ink Q2, for example, an evaporation-drying ink, such as a solvent ink, an aqueous ink, or a latex ink, is applicable.

Examples of the first ink Q1 include a color ink capable of producing a predetermined color. In addition, examples of the second ink Q2 include a colorless and transparent clear ink, a primer, and a white ink having surface free energy corresponding to the surface free energy of the first ink.

Here, the surface free energy is energy per unit area stored on a surface by work performed from the outside under a constant temperature condition. The surface free energy is a physical quantity having a dimension (for example, mJ/m²: millijoules per square meter) equivalent to surface tension.

The first ink Q1, the second ink Q2, and the print object M each have unique surface free energy. For example, when the surface free energy of the print object M is greater than the surface free energy of the first ink Q1, the droplets of the first ink Q1 easily wet-spread on the print object M. In this case, the first ink Q1 more easily wet-spreads as an absolute value of a difference between the surface free energy of the first ink Q1 and the surface free energy of the print object M increases. In addition, when the surface free energy of the print object M is less than a value of the surface free energy of the first ink Q1, the droplets of the first ink Q1 do not easily wet-spread on the print object M. In this case, wet-spreading becomes more difficult as the absolute value of the difference between the surface free energy of the first ink Q1 and the surface free energy of the print object M increases.

Similarly, for example, when the surface free energy of the print object M is greater than the surface free energy of the second ink Q2, the droplets of the second ink Q2 easily wet-spread on the print object M. In addition, when the surface free energy of the print object M is less than the surface free energy of the second ink Q2, the droplets of the second ink Q2 do not easily wet-spread on the print object M.

Further, when the surface free energy of the second ink Q2 is greater than the surface free energy of the first ink Q1, the droplets of the first ink Q1 easily wet-spread on the buffer layer formed by the second ink Q2. In addition, when the surface free energy of the second ink Q2 is less than the value of the surface free energy of the first ink Q1, the droplets of the first ink Q1 do not easily wet-spread on the buffer layer formed by the second ink Q2.

Therefore, as a result of the buffer layer formed by the second ink Q2 being interposed between the first ink Q1 and the print object M, the manner in which the first ink Q1 wet-spreads on the print object M can be adjusted.

Specifically, when the surface free energy of the first ink Q1 is less than the surface free energy of the print object M, a buffer layer having surface free energy equal to or greater than the surface free energy of the first ink Q1 is preferably interposed. In addition, when the surface free energy of the first ink Q1 is greater than the surface free energy of the print object M, a buffer layer having surface free energy equal to or less than the surface free energy of the first ink Q1 is preferably interposed.

The controller 30 includes a processing device, such as a central processing unit (CPU), and a storage device, such as a random access memory (RAM) or a read only memory (ROM).

As shown in (b) of FIG. 1, the controller 30 includes a print object information acquiring portion 31, a storage 32, a determining portion 33, a drive control portion 34, and an ejection control portion 35.

The storage 32 stores therein various types of information. The storage 32 includes, for example, storage such as a hard disk drive or a solid state drive. Note that an external storage medium, such as a removable disk, may be used as the storage 32.

The storage 32 includes physical property information storage 32a. The physical property information storage 32a stores therein physical property information associating and a type of the print object M and the surface free energy of the print object M.

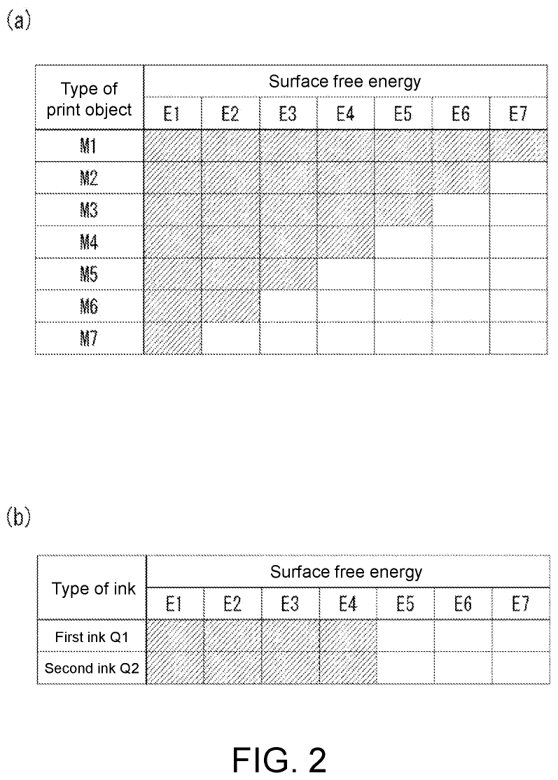

In FIG. 2, (a) is a diagram of an example of the physical property information stored in the physical property information storage 32a. As shown in (a) of FIG. 2, the physical property information storage 32a stores therein the type of the print object M and the surface free energy of the print object M in association with each other. Print objects M1 to M7 are made of differing materials. The print objects M1 to M7 have differing surface free energies. The surface free energy of the print object M1 is E7. The surface free energy of the print object M2 is E6. The surface free energy of the print object M3 is E5. The surface free energy of the print object M4 is E4. The surface free energy of the print object M5 is E3. The surface free energy of the print object M6 is E2. The surface free energy of the print object M7 is E1. In FIG. 2, (a) shows an example in which the surface free energy gradually decreases from E7 to E1, from the print object M1 toward the print object M7 (E7>E6>E5>E4>E3>E2>E1).

In addition, in (b) of FIG. 2, the first ink Q1 and the second ink Q2, and the surface free energies of the first ink Q1 and the second ink Q2 are stored in association with each other. In FIG. 2, (b) shows an example in which the first ink Q1 and the second ink Q2 have equal surface free energy E4. It goes without saying that the surface free energies of the first ink Q1 and the second ink Q2 are not limited to E4. The surface free energy of the second ink Q2 and the surface free energy of the first ink Q1 may differ from each other.

Hereinafter, a case in which the surface free energies of the first ink Q1 and the second ink Q2 are E4 will be described as an example. Here, since the buffer layer is formed by the second ink Q2, the surface free energy E4 of the second ink Q2 is also referred to as the surface free energy E4 of the buffer layer in the following description.

The print object information acquiring portion 31 acquires print object information on the type of the print object M. For example, the print object information is input by an input portion 50 (see (b) of FIG. 1). The input portion 50 may be, for example, an automatic input device, such as a camera or an optical sensor, that automatically detects the print object, or may be a manual input device, such as a keyboard or a mouse, through which a user performs input. In the case of the manual input device, for example, a configuration is possible in which options of a plurality of pieces of print object information are displayed by a display portion (not shown) or the like, and the user selects one or a plurality of pieces of print object information from the displayed options, thereby inputting the print object information. In this case, as the plurality of options, for example, the print objects M (M1 to M7) stored in the physical property information storage 32a of the storage 32 can be used.

As shown in (a) of FIG. 2, the physical property information storage 32a stores therein the plurality of types of print objects M1 to M7.

The print objects M1 to M3 have the surface free energies E7 to E5 greater than the surface free energy E4 (see (b) of FIG. 2) of the first ink Q1. The print object M4 has the surface free energy E4 (see (b) of FIG. 2) equal to the surface free energy E4 of the first ink Q1. The print objects M5 to M7 have the surface free energies E3 to E1 less than the surface free energy E4 (see (b) of FIG. 2) of the first ink Q1.

As shown in FIG. 2, the determining portion 33 determines whether or not to form the buffer layer on the print object M based on the print object information acquired by the print object information acquiring portion 31 and the information stored in the physical property information storage 32a of the storage 32.

Specifically, the determining portion 33 includes an absolute value calculating portion 33a and a threshold determining portion 33b. The determining portion 33 searches the types of the print objects M1 to M7 in the physical property information stored in the physical property information storage 32a for the type of the acquired print object M, and acquires the value of the surface free energy corresponding to the corresponding type of the print object. In addition, the determining portion 33 acquires the value of the surface free energy of the first ink Q1 stored in the physical property information storage 32a.

The determining portion 33 determines whether or not to form the buffer layer based on the difference between the acquired surface free energy of the print object M and surface free energy of the first ink Q1. For example, the determining portion 33 determines that the buffer layer is to be formed when the absolute value calculating portion 33a calculates the absolute value of the difference between the surface free energy of the print object M and the surface free energy of the first ink Q1, and the threshold determining portion 33b determines that the absolute value is equal to or greater than a threshold. Meanwhile, for example, the determining portion 33 determines that the buffer layer is not to be formed when the absolute value calculating portion 33a calculates the absolute value of the difference between the surface free energy of the print object M and the surface free energy of the first ink Q1, and the threshold determining portion 33b determines that the absolute value is less than the threshold. The threshold can be set in advance. According to the first embodiment, the threshold can be set to, for example, a difference amounting to two levels in E1 to E7.

In this case, when the absolute value of the difference between the surface free energy of the print object M and the surface free energy of the first ink Q1 is equal to or greater than two levels, the determining portion 33 determines that the buffer layer is to be formed. When the absolute value of the difference between the surface free energy of the print object M and the surface free energy of the first ink Q1 is less than two levels, the determining portion 33 determines that the buffer layer is not to be formed. Note that, in addition to the difference amounting to two levels, the threshold may be, for example, a difference of 1 mJ/m² when there is a difference between the surface free energy of the first ink Q1 and the surface free energy of the print object M. In this case, “equal to or greater than the threshold” is equal to or greater than 1 mJ/m². “Less than the threshold” is less than 1 mJ/m².

The drive control portion 34 controls a drive mechanism that moves the carriage 40 in the main scanning direction D1. The ejection control portion 35 controls an operation in which the droplets of the first ink Q1 are ejected from the first droplet ejecting portion 10 and an operation in which the droplets of the second ink Q2 are ejected from the second droplet ejecting portion 20. When the determining portion 33 determines that the buffer layer is to be formed, the ejection control portion 35 causes the second droplet ejecting portion 20 to eject the droplets of the second ink Q2 and forms the buffer layer. That is, the second droplet ejecting portion 20 constitutes a buffer layer forming portion.

FIG. 3 shows diagrams of an example of a state in which the first ink Q1 is ejected onto the print object or the buffer layer. As shown in (a) of FIG. 3, when the first ink Q1 having the surface free energy of E4 (<E7) is dropped onto a surface M1a of the print object M1 having the surface free energy of E7, the first ink Q1 wet-spreads on the surface M1a of the print object M1.

In addition, as shown in (b) of FIG. 3, when the first ink Q1 having the surface free energy of E4 (>E1) is dropped onto a surface M7a of the print object M7 having the surface free energy of E1, the first ink Q1 does not wet-spread on the surface M7a of the print object M7 and is in a raised state.

Further, as shown in (c) of FIG. 3, when the first ink Q1 having the surface free energy of E4 is dropped onto a surface Ca of a buffer layer C having the surface free energy of E4, the first ink Q1 wet-spreads less on the surface Ca of the buffer layer C than when the first ink Q1 is dropped onto the surface M1a of the print object M1, and wet-spreads more than when the first ink Q1 is dropped onto the surface M7a of the print object M7. Also in a case in which the first ink Q1 having the surface free energy of E4 is dropped onto the print object M4 having the surface free energy of E4, an arrangement state (wet-spread state) of the first ink Q1 is similar to that when the first ink Q1 is dropped onto the surface Ca of the buffer layer C.

FIG. 4 shows diagrams of an example of a state of the first ink Q1 ejected onto the buffer layer C. When the buffer layer C is formed, the second ink Q2 is ejected from the nozzle of the second droplet ejecting portion 20 over an entire predetermined region R1. The region R1 is a region including a portion in which an ink layer I is formed by the first ink Q1 on the surface of the print object M1. The buffer layer C is formed over the entire predetermined region R1 including the portion in which the ink layer I is formed.

As shown in (a) of FIG. 4, according to the first embodiment, the surface free energy of the second ink Q2 is E4. When the second ink Q2 having the surface free energy E4 (<E7) protrudes on the surface M1a of the print object M1 having the surface free energy E7, the droplets of the second ink Q2 spread on the surface M1a of the print object M1. In this state, a buffer layer C1(C) is formed. When the second ink Q2 tends to wet-spread on the surface M1a of the print object M1 in this manner, or when this tendency is pronounced, an ejection amount of the second ink Q2 may be reduced from a usual ejection amount. That is, the controller 30 usually controls the ejection amount of the droplets so as to coat the entire surface M1a of the print object M1. In contrast, when the second ink Q2 tends to wet-spread on the surface M1a of the print object M1, fewer droplets than usual are ejected. In addition, in this case, rather than the ejected droplets of the second ink Q2 all being the same size, droplets having the usual ejection amount and droplets having a smaller ejection amount than the usual droplets being ejected in combination can be considered. Alternatively, the overall ejection amount may be reduced through thinning, while the usual ejection amount is ejected.

In FIG. 4, (b) is a diagram of an example of a state of the first ink Q1 ejected onto the buffer layer C. When the buffer layer C is formed, the second ink Q2 is ejected from each nozzle of the second droplet ejecting portion 20 over an entire predetermined region R2. The region R2 is a region including a portion in which the ink layer I is formed by the first ink Q1 on the surface of the print object M7. The buffer layer C is formed over the entire predetermined region R2 including the portion in which the ink layer I is formed.

As shown in (b) of FIG. 4, when the second ink Q2 having the surface free energy of E4 (>E1) is ejected onto the surface M7a of the print object M7 having the surface free energy of E1, the droplets of the second ink Q2 do not wet-spread on the surface M7a of the print object M7 and are in a raised state. In this state, a buffer layer C2(C) is formed. When the second ink Q2 tends not to wet-spread on the surface M7a of the print object M7 in this manner and the surface of the surface M7a of the print object M7 is exposed, or when this tendency is pronounced, the ejection amount of the second ink Q2 may be increased from the usual ejection amount. That is, the controller 30 usually controls the ejection amount of the droplets so as to coat the entire surface M1a of the print object M1. In contrast, when the second ink Q2 tends not to wet-spread on the surface M1a of the print object M1, more droplets than usual are ejected. In addition, in this case, rather than the ejected droplets of the second ink Q2 all being the same size, droplets having the usual ejection amount and droplets having a greater ejection amount than the usual droplets being ejected in combination can be considered.

As shown in FIG. 4, when the first ink Q1 is dropped onto each of the print objects M1 and M7 on which the buffer layers C1 and C2 are formed, the first ink Q1 lands on surfaces C1a and C2a of the buffer layers C1 and C2 having the same surface free energy. Therefore, in an ink layer I1(I) formed on the print object M1 and an ink layer I2(I) formed on the print object M7, a degree of wet-spreading of the first ink Q1 is similar regardless of the surface free energies of the print objects M1 and M7. The buffer layer C adjusts the arrangement state of the first ink Q1 on the print object M in this manner.

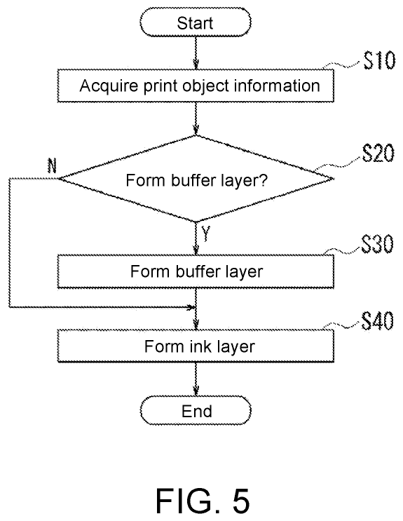

Next, a printing method using the printing device 100 configured as described above will be described. FIG. 5 is a flowchart of an example of a printing method according to the first embodiment. When print data is received from the outside, the print object information acquiring portion 31 acquires the print object information on the type of the print object M (step S10). When the print object information is acquired, the determining portion 33 determines whether or not to form the buffer layer (step S20: determining step). At step S20, the determining portion 33 searches the types of the print objects M1 to M7 in the physical property information stored in the physical property information storage 32a for the type of the acquired print object M, and acquires the value of the surface free energy corresponding to the corresponding type of the print object. In addition, the determining portion 33 acquires the surface free energy of the first ink Q1 stored in the physical property information storage 32a.

For example, as shown in FIG. 2, when the surface free energies E1 and E2 of the print objects M7 and M6 and the surface free energies E7 and E6 of the print objects M1 and M2 are acquired, the absolute value of the difference from the surface free energy E4 of the first ink Q1 is equal to or greater than the threshold (equal to or greater than two levels) as follows.

Print object M7(E1)−first ink Q1(E4)=three levels (A)

Print object M6(E2)−first ink Q1(E4)=two levels (B)

Print object M2(E6)−first ink Q1(E4)=two levels (C)

Print object M1(E7)−first ink Q1(E4)=three levels (D)

In these cases, the determining portion 33 determines that the buffer layer C is to be formed (step S20: Yes).

Meanwhile, when the surface free energies E5, E4, and E3 of the print objects M3, M4, and M5 are acquired, the absolute value of the difference from the surface free energy E4 of the first ink Q1 is less than the threshold (less than two levels) as follows.

Print object M3(E5)−first ink Q1(E4)=one level (E)

Print object M4(E4)−first ink Q1(E4)=zero levels (F)

Print object M5(E3)−first ink Q1(E4)=one level (G)

In these cases, the determining portion 33 determines that the buffer layer is not to be formed C (step S20: No).

When the determination to form the buffer layer C is made at step S20 (Yes at step S20), the controller 30 ejects the second ink Q2 from the nozzle of the second head 20 over a predetermined range including a position serving as an ejection target for the first ink Q1 on the print object M, and forms the buffer layer C in the region of the predetermined range (step S30: buffer layer forming step).

When the determination not to form the buffer layer C is made at step S20 (No at step S20) or the buffer layer C is formed (step S30), the controller 30 ejects the first ink Q1 from the nozzle of the first head 10 onto the position serving as the ejection target for the first ink Q1 on the print object M and forms the ink layer I (step S40: printing step).

By determining whether or not the buffer layer C is to be formed based on the surface free energies of both the print object M and the first ink Q1 in this manner, a difference in the degree of wet-spreading of the first ink Q1 on the print object M can be reduced.

As described above, the printing method according to the first embodiment has the following configuration.

(1) The printing method includes:
the buffer layer forming step (step S30) of forming, when there is a difference between the surface free energy of the print object M which is an object to be printed and the surface free energy of the first ink Q1 that is the coating material to be applied onto the print object M, the buffer layer C on the surface of the print object M with the buffer material having the surface free energy differing from that of the print object M or the first ink Q1; and
the printing step (step S40) of printing by applying the first ink Q1 to the buffer layer C.

As a result of such a configuration, the difference in the degree of wet-spreading of the first ink Q1 depending on the type of the print object M can be reduced.

Specifically, the buffer layer C for adjusting the arrangement state of the first ink Q1 can be formed on the surfaces of a plurality of types of print objects M having differing surface free energies, and the ink layer I can be formed by the droplets of the first ink Q1 being ejected onto the buffer layer C.

Consequently, both excessive wet-spreading and insufficient wet-spreading of the first ink Q1 can be reduced, and the difference in the degree of wet-spreading of the first ink Q1 can be reduced.

In addition, the printing device 100 according to the first embodiment has the following configuration. (2) The printing device 100 includes:
the first droplet ejecting portion 10, configured to be capable of ejecting droplets of the first ink Q1 toward the surface of the print object M;
the second droplet ejecting portion 20 (buffer layer forming portion), configured to be capable of forming the buffer layer C for adjusting the arrangement state of the first ink Q1 on the surface of the print object M; and
the controller 30, configured to cause the second droplet ejecting portion 20 to form the buffer layer C and the first droplet ejecting portion 10 to form the ink layer I on the buffer layer C, when the absolute value of the difference between the surface free energy of the print object M and the surface free energy of the first ink Q1 is equal to or greater than the threshold.

The printing device 100 being configured in this manner also enables the difference in the degree of wet-spreading of the first ink Q1 depending on the type of the print object M to be suppressed.

(3) The printing method further includes:
the determining step (step S20) of determining whether or not to form the buffer layer C based on the difference between the surface free energy of the print object M and the surface free energy of the first ink Q1, in which
when it is determined to form the buffer layer C, forming the buffer layer C on the surface of the print object M.

As a result of such a configuration, the difference in the degree of wet-spreading of the first ink Q1 can be further reduced.

(4) The determining step determines that the buffer layer C is to be formed, when the absolute value of the difference between the surface free energy of the print object M and the surface free energy of the first ink Q1 is equal to or greater than the threshold.

As a result of such a configuration, the difference in the degree of wet-spreading of the first ink Q1 can be more accurately reduced.

(5) In the printing method,
the buffer layer C is formed by using, as the buffer material, at least one of a clear ink, a primer, and an ink of the same color as the print object M having a surface free energy corresponding to the absolute value of the difference between the surface free energy of the print object M and the surface free energy of the first ink Q1.

As a result of such a configuration, the arrangement state of the first ink Q1 on the buffer layer C can be appropriately secured.

(6) The plurality of types of the print object M include: the print objects M7 to M5 having surface free energies greater than the surface free energy E4 of the first ink Q1, the print object M4 having surface free energy equal to the surface free energy E4 of the first ink Q1, and the print objects M3 to M1 having surface free energies less than the surface free energy E4 of the first ink Q1.

As a result of such a configuration, even when the ink layer I is formed on the plurality of types of the print object M having differing surface free energies, the difference in the degree of wet-spreading of the first ink Q1 can be reduced by the buffer layer C being formed.

(7) In the printing method,
the buffer layer C is formed over the entire region in which the ink layer I is formed on the surface of the print object M or the entire print object M.

As a result of such a configuration, the difference in the degree of wet-spreading of the first ink Q1 can be reduced over the entire ink layer I.

(8) The controller 30 further includes:
a storage 35, configured to store therein an information of surface free energies of a plurality of print objects M and surface free energies of a plurality of coating materials;
an absolute value calculating portion 33a, configured to calculate the absolute value of the difference between the surface free energy of the print object M to be printed and the surface free energy of the coating material, from the information of surface free energies of the plurality of print objects M and surface free energies of the plurality of coating materials;
a threshold determining portion 33b, configured to determine whether or not the absolute value is equal to or greater than the threshold; and
a determining portion 33 (buffer layer formation determining portion), configured to determine whether or not to form the buffer layer C based on the threshold.

As a result of such a configuration, whether or not to form the buffer layer C can be efficiently determined.

### Second Embodiment

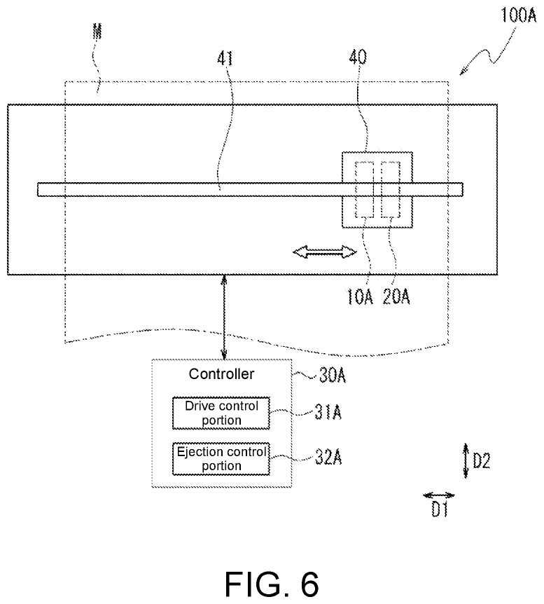

FIG. 6 is a diagram of an example of a printing device 100A according to a second embodiment.

Note that, in the following description, sections differing from those according to the first embodiment will be described. Identical sections will be described with the same reference signs.

As shown in FIG. 6, the printing device 100A includes a first head 10A, a second head 20A, and a controller 30A. The first head 10A and the second head 20 are mounted on the carriage 40. The carriage 40 is movable in the main scanning direction D1 along the guide bar 41.

The printing device 100A further includes a relative moving portion (not shown) that relatively moves the first head 10A and the second head 20A, and the print object M in the sub scanning direction D2. According to the second embodiment, a case in which a print object conveyance section that conveys the print object M in the sub scanning direction D2 is used as the relative moving portion will be described as an example.

The first head 10A is movable in the main scanning direction D1 and ejects droplets of a first ink Q1A from a nozzle onto the print object M. The second head 20A is arranged side by side with the first head 10A in the main scanning direction D1, and moves integrally with the first head 10A. The second head 20A ejects droplets of a second ink Q2A from a nozzle onto the print object M. The second ink Q2A having a higher viscosity than the first ink Q1A is used.

As the first ink Q1A and the second ink Q2A, for example, an evaporation-drying ink, such as a solvent ink, an aqueous ink, or a latex ink, is applicable.

Examples of the first ink Q1A include a color ink capable of producing a predetermined color. In addition, examples of the second ink Q2A include an ink of substantially the same color (white color) as the print object M, an ink of substantially the same color as the first ink Q1A, and a transparent ink. When the second ink Q2A is colorless or transparent, the second ink Q2A is compatible with most types of print objects M or most color types of the first ink Q1A, and is also compatible with various printing methods described later. When the second ink Q2A has substantially the same color as the print object M or the first ink Q1A, printing can be performed without compromising color tone and image quality of original image data.

The controller 30A includes a processing device, such as a central processing unit (CPU), and a storage device, such as a random access memory (RAM) or a read only memory (ROM). The controller 30A includes a drive control portion 31A and an ejection control portion 32A. The drive control portion 31A controls a drive mechanism that moves the carriage 40 in the main scanning direction D1 and the print object conveyance section that conveys the print object M in the sub scanning direction D2. The ejection control portion 32A controls an operation in which droplets of the first ink Q1A are ejected from the first head 10A and an operation in which droplets of the second ink Q2A are ejected from the second head 20A.

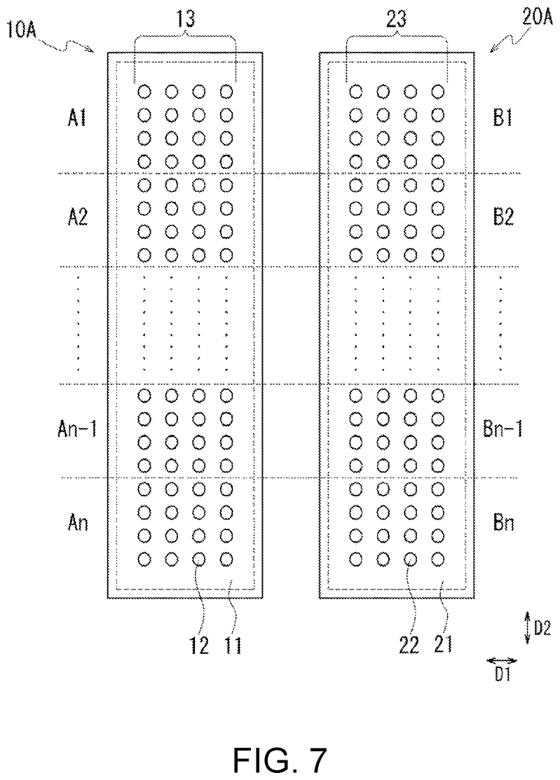

FIG. 7 is a diagram of an example of nozzle surfaces 11 and 21 sides of the first head 10A and the second head 20A.

As shown in FIG. 7, the first head 10A has the nozzle surface 11 facing the print object M. A plurality of nozzles 12 are formed on the nozzle surface 11. The plurality of nozzles 12 are arranged in the sub scanning direction D2. The plurality of nozzles 12 constitute a nozzle row 13. Four nozzle rows 13 are arranged in the main scanning direction D1. Note that the number of nozzle rows 13 is not limited to four rows, and may be three or less rows or five or more rows. The nozzle 12 ejects the droplets of the first ink Q1A. The nozzle row 13 is divided into, for example, n (n being a natural number) ejection regions A1, A2, . . . , An that divide the nozzle row 13 into n equal parts in the sub scanning direction D2. The number n of equal parts may be arbitrarily selected by the user, or may be automatically selected by the controller 30A based on the resolution of the image data to be printed.

Similarly, the second head 20A has the nozzle surface 21 facing the print object M. A plurality of nozzles 22 are formed on the nozzle surface 21. The same number of nozzles 22 as the number of nozzles 12 in the first head 10A is formed. The plurality of nozzles 22 are arranged in the sub scanning direction D2. The plurality of nozzles 22 constitute a nozzle row 23. Four nozzle rows 23 are arranged in the main scanning direction D1. Note that the number of nozzle rows 23 is not limited to four rows, and may be three or less rows or five or more rows. The nozzle 22 ejects the droplets of the second ink Q2A. The nozzle row 23 is divided into, for example, n (n being a natural number) ejection regions B1, B2, . . . , Bn that divide the nozzle row 23 into n equal parts in the sub scanning direction D2. The number n of equal parts may be arbitrarily selected by the user, or may be automatically selected by the controller 30A based on the resolution of the image data to be printed.

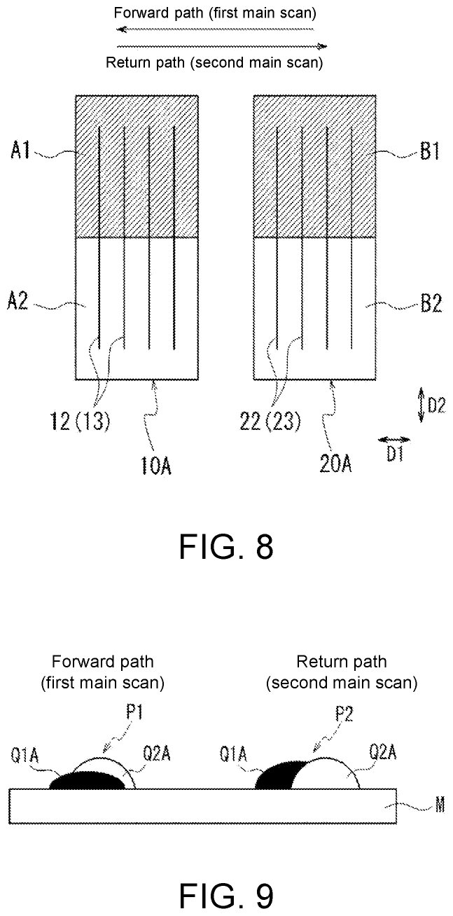

In the following description, a case where n is set to two will be described as an example. That is, the nozzle rows 13 of the first head 10A are divided into two regions that are the ejection regions A1 and A2. Further, the nozzle rows 23 of the second head 20A are divided into two regions that are the ejection regions B1 and B2 (see FIG. 8).

Next, a printing method using the printing device 100A will be described. FIG. 8 is a diagram of an example of an ejection operation in the printing method according to the second embodiment.

As shown in FIG. 8, the respective nozzle rows 13 and 23 of the first head 10A and the second head 20A are equally divided into two ejection regions (A1 and A2, B1 and B2) in the sub scanning direction D2 direction.

As shown in FIG. 8, in the main scanning direction D1, the ejection region A1 of the first head 10A and the ejection region B1 of the second head 20A are adjacent to each other with a gap therebetween. In the main scanning direction D1, the ejection region A2 of the first head 10A and the ejection region B2 of the second head 20A are adjacent to each other with a gap therebetween.

Further, in the sub scanning direction D2, the ejection region A1 of the first head 10A and the ejection region B2 of the second head 20A are arranged so as to be continuous without a gap. In the sub scanning direction D2, the ejection region A2 of the first head 10A and the ejection region B1 of the second head 20A are arranged so as to be continuous without a gap.

The controller 30A controls operation of the first head 10A and the second head 20A based on print data from the outside. The controller 30A sets a target landing position on the print object M on which the droplet of the first ink Q1A is to land based on the print data.

When ejecting the first ink Q1A onto the print object M, the controller 30A reciprocates the carriage 40 in the main scanning direction D1.

According to the second embodiment, the following case will be described as an example.
(i) On a forward path, the first head 10A leads and the second head 20A follows the first head 10A.
(ii) On a return path, the second head 20A leads and the first head 10A follows the second head 20A.

Note that the reciprocating movement of the carriage 40 is not limited to the above (i) and (ii). For example, the carriage 40 may be moved such that the second head 20A leads and the first head 10A follows the second head 20A on the forward path, and the first head 10A leads and the second head 20A follows the first head 10A on the return path.

First, in a first main scan (forward path), the controller 30A causes the nozzles 12 arranged in the ejection region A1 of the nozzle rows 13 of the first head 10A to eject droplets of the first ink Q1A (hatched region in FIG. 8).

The controller 30A controls the movement of the carriage 40 in the main scanning direction D1 and the timing of ejection by the nozzles 12 so that the droplets of the first ink Q1A land on the target landing positions on the print object M.

In addition, in the first main scan (forward path), the controller 30A causes the nozzles 22 arranged in the ejection region B1 of the nozzle rows 23 of the second head 20A to eject droplets of the second ink Q2A (hatched region in FIG. 8).

The controller 30A controls the movement of the carriage 40 in the main scanning direction D1 and the timing of ejection by the nozzles 22 so that the droplets of the second ink Q2A land on the target landing positions of the first ink Q1A on the print object M. That is, the controller 30A controls the movement of the carriage 40 in the main scanning direction D1 and the timing of ejection by the nozzles 22 so that the droplets of the second ink Q2A overlap the first ink Q1A that has landed earlier on the target landing positions on the print object M, so as to correspond one-to-one.

After the first main scan is completed, the print object conveyance section conveys the print object M in the sub scanning direction D2. A conveyance distance at this time is half the length of the nozzle rows 13 and 23 of the first head 10A and the second head 20A. The conveyance distance is set to be half the length of the nozzle rows 13 and 23 because the above-described ejection region is half the nozzle rows 13 and 23. When the ejection region is set to a number n that is other than two equal parts, the conveyance distance being set to 1/n of the length of the nozzle rows 13 and 23 can be considered.

After the print object M is conveyed in the sub scanning direction D2, a second main scan (return path) is performed. In the second main scan, the controller 30A causes the nozzles 22 arranged in the ejection region B1 of the second head 20A to eject droplets of the second ink Q2A. The controller 30A controls the movement of the carriage 40 in the main scanning direction D1 and the timing of ejection by the nozzles 22 so that the droplets of the second ink Q2A land earlier on the target landing positions on the print object M for the first ink Q1A that is ejected from the first head 10A that follows.

In addition, in the second main scan (return path), the controller 30A causes the nozzles 12 arranged in the ejection region A1 of the first head 10A to eject droplets of the first ink Q1A. At this time, the controller 30A controls the movement of the carriage 40 in the main scanning direction D1 and the timing of ejection by the nozzles 12 so that the droplets of the first ink Q1A land on the target landing positions on the print object M. That is, the controller 30A controls the movement of the carriage 40 in the main scanning direction D1 and the timing of ejection by the nozzles 12 so that the droplets of the first ink Q1A overlap the second ink Q2A that has landed earlier on the target landing positions on the print object M, so as to correspond one-to-one.

FIG. 9 is a diagram of an example of a state of the first ink Q1A and the second ink Q2A ejected onto the print object M in the respective main scans on the forward path and the return path.

As shown in FIG. 9, in the first main scan (forward path), first, the first ink Q1A lands on a target landing position P1 on the print object M. Next, the second ink Q2A lands so as to overlap the first ink Q1A in a one-to-one manner.

Here, the second ink Q2A has a higher viscosity than the first ink Q1A. The first ink Q1A more easily wet-spreads upon landing than the second ink Q2A. Meanwhile, the second ink Q2A less easily wet-spreads upon landing than the first ink Q1A. By the second ink Q2A overlapping the first ink Q1A in a one-to-one manner after the first ink Q1A is ejected, the first ink Q1A becomes attached to the second ink Q2A. As a result, the wet-spreading of the first ink Q1A is reduced.

In addition, as shown in FIG. 9, in the second main scan (return path), first, the second ink Q2A lands on a target landing position P2 on the print object M. Next, the first ink Q1A lands so as to overlap the second ink Q2A in a one-to-one manner.

By the first ink Q1A overlapping the second ink Q2A in a one-to-one manner after the second ink Q2A is ejected, the first ink Q1A becomes attached to the second ink Q2A. As a result, the wet-spreading of the first ink Q1A is reduced.

After the second main scan is completed, the print object conveyance section conveys the print object M by a predetermined distance in the sub scanning direction D2. The conveyance distance at this time is half the length of a single row of the nozzles 12 and 22, similar to that after the completion of the first main scan. After the print object M is conveyed in the sub scanning direction D2, scanning on the forward path in the main scanning direction D1 is performed. As a result of scanning in the main scanning direction D1 by the first head 10A and the second head 20A, and conveyance of the print object M in the sub scanning direction D2 being repeatedly performed in this manner, printing on the print object M based on the print data can be performed.

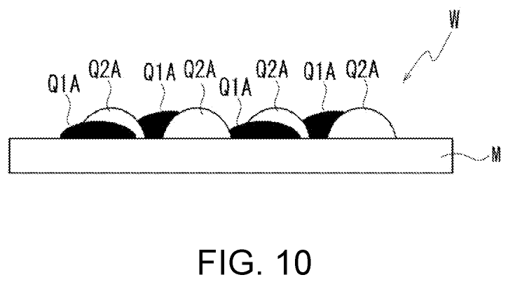

FIG. 10 is a diagram of an example of a state of the first ink Q1A and the second ink Q2A on the print object M when a printing operation is completed.

On the print object M after the printing operation is completed, the first ink Q1A is arranged on the target landing positions based on the print data, and the first ink Q1A and the second ink Q2A have landed so as to overlap in a one to-one-manner.

Here, the first ink Q1A and the second ink Q2A are ejected from the first head 10A and the second head 20A that are in differing positions. Therefore, as shown in FIG. 10, a droplet of ink ejected following a droplet of ink that has landed earlier on the print object M does not land on the top of the earlier droplet of ink, and the inks land so that the top of each ink is slightly shifted from the other. As a result, the first ink Q1A is attached to the print object M and the second ink Q2A so as to extend therebetween.

A printed matter W including the droplets of the first ink Q1A and the droplets of the second ink Q2A is formed in this manner. In the printed matter W, the droplet of the first ink Q1A is arranged on each target landing position on the print object M, and the second ink Q2A is arranged to overlap each droplet of the first ink Q1A. Therefore, the printed matter W in which the wet-spreading of the first ink Q1A is reduced is formed.

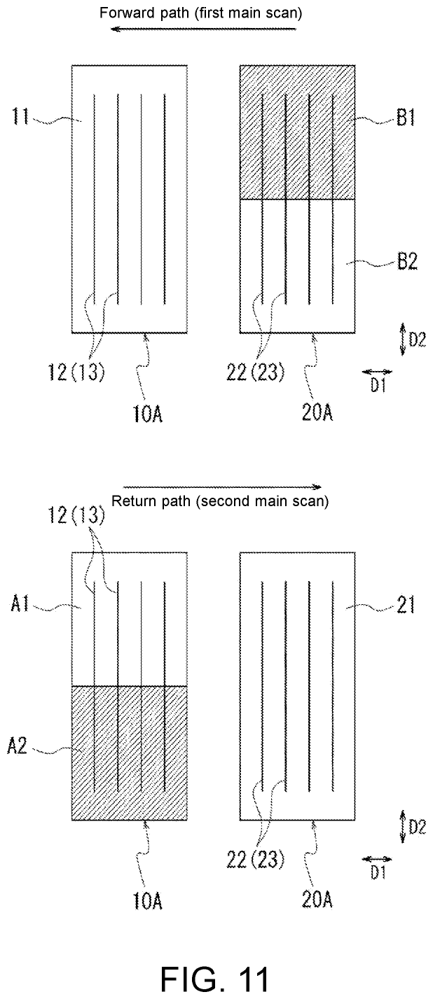

FIG. 11 is a diagram of another example of the ejection operation in the printing method according to the second embodiment and is a diagram in which the number n of the plurality of ejection regions shown in FIG. 7 is two.

As shown in FIG. 11, first, regarding the first main scan (forward path), the controller 30A causes the nozzles 22 arranged in the ejection region B1 of the nozzle rows 23 of the second head 20A to eject droplets of the second ink Q2A (hatched region in FIG. 11).

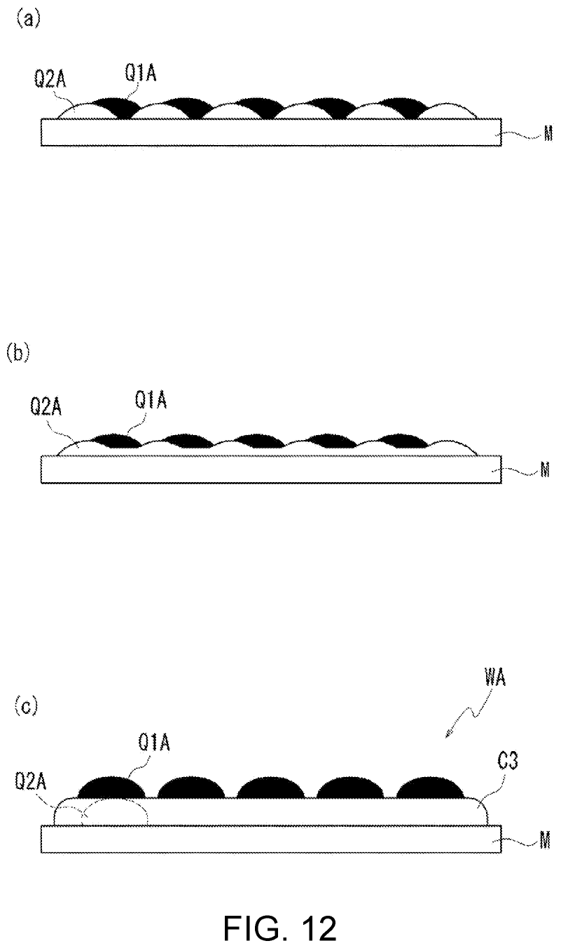

The controller 30A controls the movement of the carriage 40 in the main scanning direction D1 and the timing of ejection by the nozzles 22 so that the droplets of the second ink Q2A land on the entire surface of a predetermined region including the target landing positions on the print object M. As a result of the first main scan, a base layer C3 (see FIG. 12) made of the second ink Q2A is formed on the print object M.

After the first main scan is completed, the print object conveyance section conveys the print object M in the sub scanning direction D2 by a distance that is half the length of the nozzle rows 13 and 23 in the first head 10A and the second head 20A. The conveyance distance is set to be half the nozzle rows 13 and 23 because the above-described ejection region is half the nozzle rows 13 and 23. When the ejection region is set to a number n that is other than two equal parts, the conveyance distance being set to 1/n of the length of the nozzle rows 13 and 23 can be considered.

After the print object M is conveyed in the sub scanning direction D2, regarding the second main scan (return path), the controller 30A causes the nozzles 12 arranged in the ejection region A2 of the first head 10A to eject droplets of the first ink Q1A (hatched region in FIG. 11).

The controller 30A controls the movement of the carriage 40 in the main scanning direction D1 and the timing of ejection by the nozzles 12 so that the droplets of the first ink Q1A land on the target landing positions on the print object M. That is, the controller 30A controls the movement of the carriage 40 in the main scanning direction D1 and the timing of ejection by the nozzles 12 so that the droplets of the first ink Q1A overlap the second ink Q2A that has landed on the target landing positions, among a plurality of second inks Q2A that have landed on the entire surface of the predetermined region of the print object M, so as to correspond one-to-one.

After the second main scan is completed, the print object conveyance section conveys the print object M in the sub scanning direction D2 by a distance that is half the length of the nozzle rows 13 and 23 in the first head 10A and the second head 20A similar to that after the first main scan, and performs scanning on the forward path in the main scanning direction D1.

FIG. 12 shows diagrams of an example of a state of the first ink Q1A and the second ink Q2A on the print object M when the printing operation shown in FIG. 11 is completed. As shown in (c) of FIG. 12, on the print object M, the second ink Q2A forms the base layer C3 on the print object M. In addition, the first ink Q1A forms an ink layer on the base layer C3. The first ink Q1A constituting the ink layer is in a state of having landed so as to overlap the second ink Q2A of the base layer C3 in a one-to-one manner Therefore, the wet-spreading of the first ink Q1A is reduced. The printed matter WA in which the wet-spreading of the first ink Q1A is reduced is formed in this manner.

Here, the state of the second ink Q2A after landing on the print object M changes depending on the size or ejection amount of the droplets when the second ink Q2A is ejected. For example, the second ink Q2A may be in a state in which the second inks Q2A that have landed do not overlap each other (see (a) of FIG. 12), a state in which only peripheral edge portions of the second inks Q2A that have landed overlap each other (see (b) of FIG. 12), and the like. Since the first ink Q1A and the second ink Q2A are ejected from the first head 10A and the second head 20A that are differing heads, a droplet of ink ejected following a droplet of ink that has landed earlier on the print object M does not land on the top of the earlier droplet of ink, and the inks land so that the top of each ink is slightly shifted from the other. Even in such a state, the wet-spreading of the first ink Q1A is reduced.

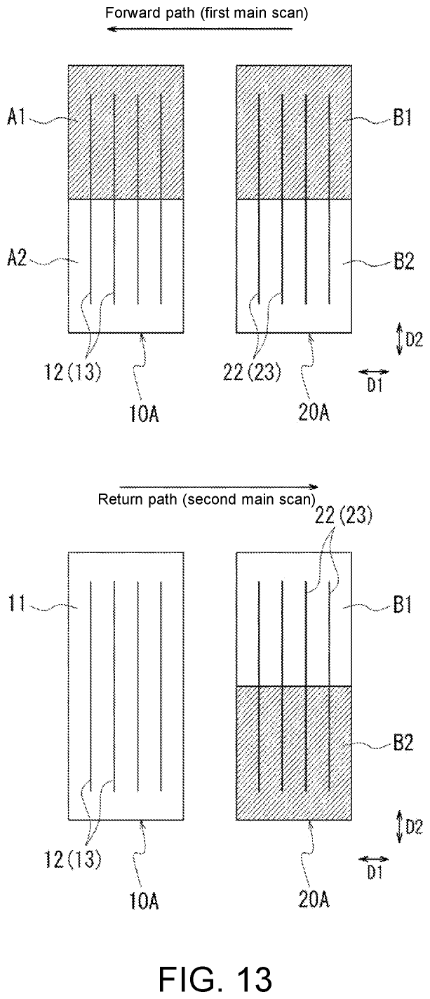

FIG. 13 is a diagram of another example of the ejection operation in the printing method according to the second embodiment. FIG. 13 is a diagram in which the number n of the plurality of ejection regions shown in FIG. 7 is set to two.

As shown in FIG. 13, first, regarding the first main scan (forward path), the controller 30A causes the nozzles 12 arranged in the ejection region A1 of the nozzle rows 13 of the first head 10A to eject droplets of the first ink Q1A (hatched region in FIG. 13).

The controller 30A controls the movement of the carriage 40 in the main scanning direction D1 and the timing of ejection by the nozzles 12 so that the droplets of the first ink Q1A land on the target landing positions on the print object M.

In addition, in the first main scan (forward path), the controller 30A causes the nozzles 22 arranged in the ejection region B1 of the nozzle rows 23 of the second head 20A to eject droplets of the second ink Q2A (hatched region in FIG. 13).

The controller 30A controls the movement of the carriage 40 in the main scanning direction D1 and the timing of ejection by the nozzles 22 so that the droplets of the second ink Q2A land on the target landing positions of the first ink Q1A on the print object M. That is, the controller 30A controls the movement of the carriage 40 in the main scanning direction D1 and the timing of ejection by the nozzles 22 so that the droplets of the second ink Q2A overlap the first ink Q1A that has landed earlier on the target landing positions on the print object M, so as to correspond one-to-one.

After the first main scan is completed, the print object conveyance section conveys the print object M in the sub scanning direction D2 by a distance that is half the length of the nozzle rows 13 and 23 in the first head 10A and the second head 20A. The conveyance distance is set to be half the nozzle rows 13 and 23 because the above-described ejection region is half the nozzle rows 13 and 23. When the ejection region is set to a number n that is other than two equal parts, the conveyance distance being set to 1/n of the length of the nozzle rows 13 and 23 can be considered.

After the print object M is conveyed in the sub scanning direction D2, the second main scan (return path) is performed. In the second main scan, the controller 30A causes the nozzles 22 arranged in the ejection region B2 of the nozzle rows 23 of the second head 20A to eject droplets of the second ink Q2A (hatched region in FIG. 13).

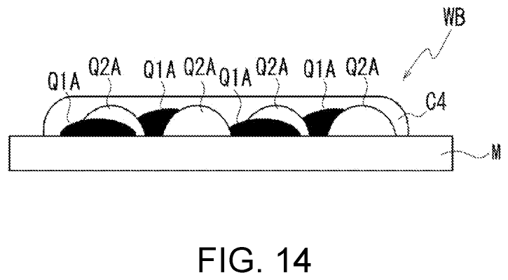

The controller 30A controls the movement of the carriage 40 in the main scanning direction D1 and the timing of ejection by the nozzles 22 so that the droplets of the second ink Q2A land on the entire surface of a predetermined region including the target landing positions on the print object M. As a result of the second main scan, a coating layer C4 (see FIG. 14) is formed on the print object M.

FIG. 14 is a diagram of an example of a state of the first ink Q1A and the second ink Q2A on the print object M when the printing operation shown in FIG. 13 is completed.

As shown in FIG. 14, in the first main scan, the first ink Q1A lands first on the target landing position on the print object M. Next, the second ink Q2A lands so as to overlap the first ink Q1A in a one-to-one manner. In addition, in the second main scan, the coating layer C4 is formed so as to coat the layers of the first ink Q1A and the second ink Q2A formed in the first main scan.

As a result of such a printing operation, the second ink Q2A can reduce the wet-spreading of the first ink Q1A and coat the image formed with the first ink Q1A. Consequently, a printed matter WB having improved fastness and glossiness can be obtained.

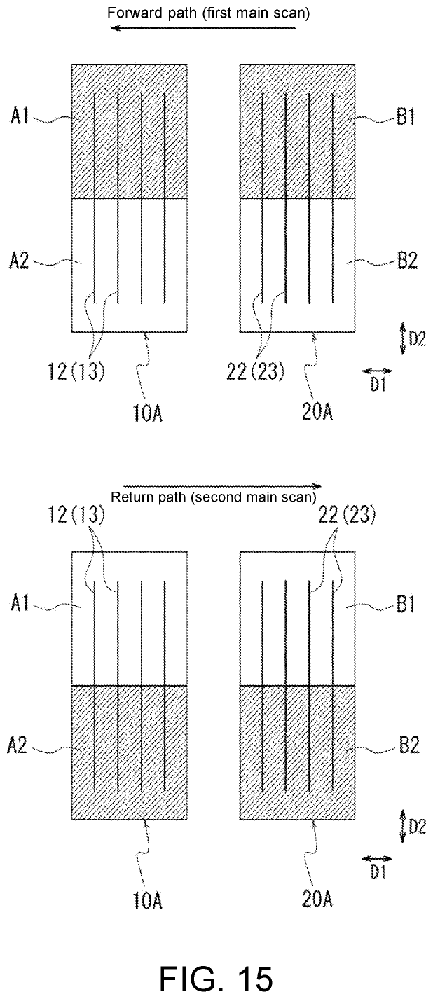

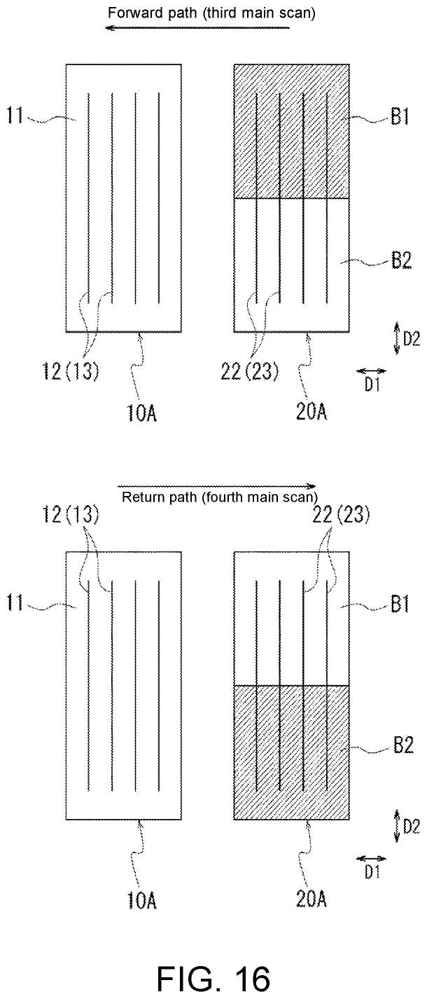

FIG. 15 and FIG. 16 are diagrams of other examples of the ejection operation in the printing method according to the second embodiment.

As shown in FIG. 15, in the first main scan (forward path), the controller 30A causes the nozzles 12 arranged in the ejection region A1 of the nozzle rows 13 of the first head 10A to eject droplets of the first ink Q1A (hatched region in FIG. 15). In addition, the controller 30A causes the nozzles 22 arranged in the ejection region B1 of the nozzle rows 23 of the second head 20A to eject droplets of the second ink Q2A (hatched region in FIG. 15).

After the first main scan is completed, the print object conveyance section conveys the print object M in the sub scanning direction D2 by a distance that is half the length of the nozzle rows 13 and 23 in the first head 10A and the second head 20A. The conveyance distance is set to be half the nozzle rows 13 and 23 because the above-described ejection region is half the nozzle rows 13 and 23. When the ejection region is set to a number n that is other than two equal parts, the conveyance distance being set to 1/n of the length of the nozzle rows 13 and 23 can be considered.

In the second main scan (return path), the controller 30A causes the nozzles 22 arranged in the ejection region B2 of the nozzle rows 23 of the second head 20A to eject droplets of the second ink Q2A (hatched region in FIG. 15). In addition, the controller 30A causes the nozzles 12 arranged in the ejection region A2 of the nozzle rows 13 of the first head 10A to eject droplets of the first ink Q1A (hatched region in FIG. 15).

In the first main scan and the second main scan, the controller 30A ejects the droplets of the first ink Q1A and the droplets of the second ink Q2A in an overlapping manner so as to correspond one-to-one on the target landing positions of the droplets of the first ink Q1A on the print object M.

After the second main scan, the print object conveyance section returns the print object M in the sub scanning direction D2 by a distance that is half the length of the nozzle rows 13 and 23 in the first head 10A and the second head 20A. That is, the print object M is returned to the position from which the first main scan is performed. Thereafter, a third main scan (forward path) is performed (see FIG. 16).

As shown in FIG. 16, in the third main scan (forward path), the controller 30A causes the nozzles 22 arranged in the ejection region B1 of the nozzle rows 23 of the second head 20A to eject droplets of the second ink Q2A (hatched region in FIG. 16).

The controller 30A controls the movement of the carriage 40 in the main scanning direction D1 and the timing of ejection by the nozzles 22 so that the droplets of the second ink Q2A land on the entire surface of a predetermined region including the target landing positions on the print object M.

After the third main scan is completed, the print object conveyance section conveys the print object M in the sub scanning direction D2 by a distance that is half the length of the nozzle rows 13 and 23 in the first head 10A and the second head 20A. Thereafter, a fourth main scan (return path) is performed.

In the fourth main scan (return path), the controller 30A causes the nozzles 22 arranged in the ejection region B2 of the nozzle rows 23 of the second head 20A to eject droplets of the second ink Q2A (hatched region in FIG. 16).

The controller 30A controls the movement of the carriage 40 in the main scanning direction D1 and the timing of ejection by the nozzles 22 so that the droplets of the second ink Q2A ejected from the nozzles 22 land on the entire surface of a predetermined region including the target landing positions on the print object M.

As a result of the third main scan and the fourth main scan, a coating layer similar to the coating layer C4 (see FIG. 14) is formed on the print object M. Consequently, a printed matter in which the wet-spreading of the first ink Q1A is reduced is formed.

As described above, the printing method according to the second embodiment has the following configuration. (9) The printing method includes:
ejecting droplets of the first ink Q1A from the nozzles 12 of the first head 10A onto the print object M while moving the first head 10A in the main scanning direction D1; and
ejecting droplets of the second ink Q2A having a higher viscosity than the first ink Q1A from the nozzles 22 of the second head 20A onto the print object M, the second head 20A being arranged side by side with the first head 10A in the main scanning direction D1 and moving integrally with the first head 10A, in which
the droplets of the first ink Q1A and the droplets of the second ink Q2A are ejected in an overlapping manner so as to correspond one-to-one on the target landing positions of the droplets of the first ink Q1A on the print object M.

As a result of such a configuration, the difference in the degree of wet-spreading of the first ink Q1A depending on the viscosity of ink can be suppressed.

Specifically, the droplets of the first ink Q1A and the droplets of the second ink Q2A are ejected in an overlapping manner so as to correspond one-to-one on the target landing positions of the droplets of the first ink Q1A on the print object M. The droplets of the first ink Q1A can thereby be brought into contact with the second ink Q2A. Consequently, the wet-spreading of the first ink Q1A can be reduced.

In addition, the printing device 100A according to the second embodiment has the following configuration. (10) The printing device 100A includes:
the first head 10A that is movable in the main scanning direction D1 and ejects droplets of the first ink Q1A from the nozzles 12 onto the print object M;
the second head 20A that is movable in the main scanning direction D1 and ejects droplets of the second ink Q2A from the nozzles 22 onto the print object M; and
the controller 30A that controls the ejection operation of the first head 10A and the second head 20A.

The second head 20A is arranged side by side with the first head 10A in the main scanning direction D1, and moves integrally with the first head 10A.

Here, the droplets of the second ink Q2A have a higher viscosity than the first ink Q1A.

The controller 30A controls the ejection operation of the first head 10A and the second head 20A so that the droplets of the first ink Q1A and the droplets of the second ink Q2A overlap each other so as to correspond one-to-one on the target landing positions of the droplets of the first ink Q1A on the print object M.

The printing device 100A being configured in this manner also enables the difference in the degree of wet-spreading of the first ink Q1A to be suppressed.

(11) In the printing method,
the droplets of the second ink Q2A are ejected onto the target landing positions and the droplets of the first ink Q1A are subsequently ejected so as to overlap the droplets of the second ink Q2A, when the ejection of the droplets of the second ink Q2A is performed before the ejection of the droplets of the first ink Q1A on a target position.

As a result of such a configuration, when the second ink Q2A is ejected before the first ink Q1A, the droplets of the first ink Q1A can be brought into contact with the second ink Q2A.

(12) In the printing method,
the droplets of the first ink Q1A are ejected onto the target landing positions and the droplets of the second ink Q2A that are droplets having high viscosity are subsequently ejected so as to overlap the droplets of the first ink Q1A, when the ejection of the droplets of the first ink Q1A is performed before the ejection of the droplets of the second ink Q2A on a target position.

As a result of such a configuration, when the first ink Q1A is ejected before the second ink Q2A, the droplets of the first ink Q1A can be brought into contact with the second ink Q2A.

(13) In the printing method,
in a single main scan of the first head 10A and the second head 20A, the droplets of the first ink Q1A and the droplets of the second ink Q2A are ejected in an overlapping manner on the target landing positions.

As a result of such a configuration, the droplets of the first ink Q1A can be brought into contact with the second ink Q2A in a single main scan.

(14) The printing method
uses the first head 10A and the second head 20A respectively having the nozzle rows 12 and 13 constituted by the plurality of nozzles 12 and 22 arranged in the sub scanning direction D2. The numbers of nozzles 12 and 22 are the same.

For each main scan, ejection control is performed by the nozzle row 13 of the first head 10A being divided into the ejection regions A1 and A2 (segments) that divide the nozzle row 13 into two equal parts (N equal parts: N being a natural number) in the sub scanning direction D2.

For each main scan, ejection control is performed by the nozzle row 23 of the second head 20A being divided into the ejection regions B1 and B2 (segments) that divide the nozzle row 23 into two equal parts (N equal parts: N being a natural number) in the sub scanning direction D2.

The nozzle rows 13 and 23 from which the inks are ejected from the first head 10A and the second head 20A for each main scan are the nozzles in the ejection regions A1 and B1 adjacent to each other in the main scanning direction D1.

As a result of such a configuration, a layer of the first ink Q1A and a layer of the second ink Q2A can be formed for each region in the sub scanning direction D2.

(15) In the printing method,
the base layer C3 is formed by droplets of the second ink Q2A being ejected in a predetermined region on the print object M including the target landing positions in a single main scan of the first head 10A and the second head 20A, and the first ink Q1A is subsequently ejected so as to overlap the second ink Q2A ejected onto the target landing positions of the base layer C3 in a subsequent scan of the first head 10A and the second head 20A.

As a result of such a configuration, even when the first ink Q1A is ejected onto the base layer C3, the droplets of the first ink Q1A can be brought into contact with the second ink Q2A.

(16) The printing method uses the first head 10A and the second head 20A respectively having the nozzle rows 12 and 13 constituted by the plurality of nozzles 12 and 22 arranged in the sub scanning direction D2.

The numbers of nozzles 12 and 22 are the same.

For each main scan, ejection control is performed by the nozzle row 13 of the first head 10A being divided into the ejection regions A1 and A2 (segments) that divide the nozzle row 13 into two equal parts (N equal parts: N being a natural number) in the sub scanning direction D2.

For each main scan, ejection control is performed by the nozzle row 23 of the second head 20A being divided into the ejection regions B1 and B2 (segments) that divide the nozzle row 23 into two equal parts (N equal parts: N being a natural number) in the sub scanning direction D2.

In a single main scan, the droplets of the second ink Q2A are ejected from the nozzles 22 in the ejection region B1, which is one of the segments dividing the nozzle row 23 of the second head 20A into two equal parts.

After the droplets of the second ink Q2A are ejected, the print object M is conveyed in the sub scanning direction D2 by a nozzle row length dividing the nozzle row into two equal parts.

In the subsequent main scan, the first head 10A ejects droplets of the first ink Q1A from the nozzles 12 in the ejection region A2, which is a segment continuous with the ejection region B1 of the second head 20A, in the sub scanning direction D2.

As a result of such a configuration, a layer of the first ink Q1A and a layer of the second ink Q2A can be formed for each region in the sub scanning direction D2.

(17) In the printing method,
at least droplets of the first ink Q1A are ejected onto the target landing positions, and the coating layer C4 is subsequently formed by the second ink Q2A being ejected onto a predetermined region on the print object M including the target landing position.

As a result of such a configuration, the layer of the first ink Q1A can be protected by the coating layer C4 in a state in which the wet-spreading of the first ink Q1A is reduced.

In addition, the printed matter W according to the second embodiment has the following configuration. (18) The printed matter W includes:
the print object M;
the droplets of the first ink Q1A arranged on the target landing positions on the print object M; and
the droplets of the second ink Q2A having a higher viscosity than the first ink Q1A.

The second ink Q2A is arranged overlapping the droplet of the first ink Q1A so as to correspond one-to-one on the target landing position on which the first ink Q1A is arranged.

As a result of such a configuration, the printed matter W in which the wet-spreading of the first ink Q1A is reduced can be provided.

(19) The second ink Q2A is at least one of an ink of the same type of color as the first ink Q1A, an ink of the same type of color as the print object M, and a transparent ink.

As a result of such a configuration, printing can be performed without compromising the color tone and image quality of the original image data.

The technical scope of the present invention is not limited to the above embodiments. Modifications can be made as appropriate without departing from the spirit of the present invention.

### REFERENCE SIGNS LIST

100, 100A Printing device
10 First droplet ejecting portion (droplet ejecting portion)
10A First head
12 Nozzle
13 Nozzle row
20 Second droplet ejecting portion (buffer layer forming portion)
20A Second head
22 Nozzle
23 Nozzle row
30, 30A Controller
33 Determining portion (buffer layer formation determining portion)
33a Absolute value calculating portion
33b Threshold determining portion
40 Carriage
A1, A2 Ejection region (segment)
B1, B2 Ejection region (segment)
C Buffer layer
C3 Base layer
C4 Coating layer
D1 Main scanning direction
D2 Sub scanning direction
I Ink layer
M Print object
Q1, Q1A First ink
Q2, Q2A Second ink
W, WA, WB Printed matter

1. A printing method comprising:
a buffer layer forming step of forming, when there is a difference between a surface free energy of a print object which is an object to be printed and a surface free energy of a coating material to be applied to a surface of the print object, a buffer layer on the surface of the print object with a buffer material having a surface free energy differing from that of the print object or the coating material; and
a printing step of printing by applying the coating material to the buffer layer.

2. The printing method as set forth in claim 1, further comprising:
a determining step of determining whether or not to form the buffer layer based on the difference between the surface free energy of the print object and the surface free energy of the coating material, wherein
when it is determined to form the buffer layer, forming the buffer layer on the surface of the print object.

3. The printing method as set forth in claim 2, wherein
the determining step determines that the buffer layer is to be formed, when an absolute value of the difference between the surface free energy of the print object and the surface free energy of the coating material is equal to or greater than a threshold.

4. The printing method as set forth in claim 3, wherein
the buffer layer is formed by using, as the buffer material, at least one of a clear ink, a primer, and an ink of same color as the print object having a surface free energy corresponding to the absolute value of the difference between the surface free energy of the print object and the surface free energy of the coating material.

5. The printing method as set forth in claim 1, wherein
the print object includes:
a print object having a surface free energy greater than the surface free energy of the coating material, and
a print object having a surface free energy less than the surface free energy of the coating material.

6. The printing method as set forth in claim 1, wherein
the buffer layer is formed over an entire region in which the coating material is applied on the surface of the print object or an entire surface of the print object.

7. A printing device comprising:
a droplet ejecting portion, configured to be capable of ejecting droplets of a coating material toward a surface of a print object;
a buffer layer forming portion, configured to be capable of forming a buffer layer that adjusts an arrangement state of the coating material on the surface of the print object; and
a controller, configured to cause the buffer layer forming portion to form the buffer layer and the droplet ejecting portion to apply the coating material onto the buffer layer, when an absolute value of a difference between a surface free energy of the print object and a surface free energy of the coating material is equal to or greater than a threshold.

8. The printing device as set forth in claim 7, wherein
the controller further includes:
a storage, configured to store therein an information of surface free energies of a plurality of print objects and surface free energies of a plurality of coating materials;
an absolute value calculating portion, configured to calculate the absolute value of the difference between the surface free energy of the print object to be printed and the surface free energy of the coating material, from the information of surface free energies of the plurality of print objects and surface free energies of the plurality of coating materials;
a threshold determining portion, configured to determine whether or not the absolute value is equal to or greater than the threshold; and
a buffer layer formation determining portion, configured to determine whether or not to form the buffer layer based on the threshold.

9. A printing method comprising:
ejecting droplets of a first ink from a nozzle of a first head onto a print object while moving the first head in a main scanning direction set in advance; and
ejecting droplets of a second ink having a higher viscosity than that of the first ink from a nozzle of a second head onto the print object, the second head being arranged side by side with the first head in the main scanning direction and moving integrally with the first head,
wherein
the droplets of the first ink and the droplets of the second ink are ejected in an overlapping manner so as to correspond one-to-one on target landing positions for the droplets of the first ink on the print object.

10. The printing method as set forth in claim 9, wherein
the second ink is at least one ink among an ink of same type of color as the first ink, an ink of same type of color as the print object, and a transparent ink.

11. The printing method as set forth in claim 9, wherein
the droplets of the second ink are ejected onto the target landing positions and the droplets of the first ink are subsequently ejected so as to overlap the droplets of the second ink, when ejection of the droplets of the second ink is performed before ejection of the droplets of the first ink onto the target landing positions.

12. The printing method as set forth in claim 9, wherein
the droplets of the first ink are ejected onto the target landing positions and the droplets of the second ink are subsequently ejected so as to overlap the droplets of the first ink, when ejection of the droplets of the first ink is performed before ejection of the droplets of the second ink onto the target landing positions.

13. The printing method as set forth in claim 9, wherein:
in a single main scan of the first head and the second head, the droplets of the first ink and the droplets of the second ink are ejected in an overlapping manner on the target landing positions.

14. The printing method as set forth in claim 9, wherein
the printing method uses the first head and the second head respectively having nozzle rows constituted by same number of nozzles that are arranged in a sub scanning direction orthogonal to the main scanning direction;
for each main scan, an ejection control is performed by the nozzle rows being divided into segments that divide the nozzle rows into N equal parts in the sub scanning direction, wherein N is a natural number; and
for each main scan, the nozzles from which ink is ejected from the first head and the second head are nozzles of segments adjacent to each other in the main scanning direction.

15. The printing method as set forth in claim 9, wherein
a base layer is formed by the droplets of the second ink being ejected in a predetermined region on the print object including the target landing positions in a single main scan of the first head and the second head, and the first ink is subsequently ejected so as to overlap the second ink ejected onto the target landing positions on the base layer in a subsequent main scan continuing from the single main scan of the first head and the second head.

16. The printing method as set forth in claim 15, wherein
the printing method uses the first head and the second head respectively having nozzle rows constituted by same number of nozzles that are arranged in a sub scanning direction orthogonal to the main scanning direction;
for each main scan, an ejection control is performed by the nozzle rows being divided into segments that divide the nozzle rows into N equal parts in the sub scanning direction, wherein N is a natural number;
in the single main scan, the droplets of the second ink are ejected from the nozzles of a single segment among the segments of N equal parts among the nozzle rows of the second head;
the print object is conveyed in the sub scanning direction by a nozzle row length dividing the nozzle rows into N equal parts; and
in the subsequent main scan, the first head ejects the droplets of the first ink from the nozzles in the segment continuous with the segment from which the droplets of the second ink are ejected from the second head in the sub scanning direction.

17. The printing method as set forth in claim 9, wherein
at least the droplets of the first ink are ejected onto the target landing positions, and a coating layer is subsequently formed by the second ink being ejected onto a predetermined region on the print object including the target landing position.

18. (canceled)

19. (canceled)

20. (canceled)
